(19) United States
(12) Patent Application Publication
(10) Pub. No.: US 2025/0139948 A1
(43) Pub. Date: May 1, 2025

(54) COMPUTER SYSTEMS AND METHODS FOR TRAINING AND USING IMAGE SEGMENTATION MODELS TO DETECT RESIDENT SPACE OBJECTS, FOR GENERATING SIMULATED TRAINING IMAGES THEREFOR, AND FOR DETECTING AND TRACKING RESIDENT SPACE OBJECTS

(71) Applicant: MDA Systems Ltd., Richmond (CA)

(72) Inventors: Dominique Low, Vancouver (CA); Christos Koulas, North Cowichan (CA); Domenico Di Giovanni, Vancouver (CA); Jerry Lim, Delta (CA); Balaji Shankar Kumar, Maple Ridge (CA); Aryeh Fayerman, Vancouver (CA); Payam Mousavi, Coquitlam (CA); Jelena Sirovljevic, Burnaby (CA)

(21) Appl. No.: 18/932,056

(22) Filed: Oct. 30, 2024

Related U.S. Application Data
(60) Provisional application No. 63/594,536, filed on Oct. 31, 2023.

(51) Int. Cl. G06V 10/774; G06F 16/29; G06V 10/25

(52) U.S. Cl. CPC G06V 10/774; G06F 16/29; G06V 10/25; G06V 2201/07

(57) ABSTRACT

A method of generating a simulated image for training a model to detect resident space objects (RSOs), a method of training the model, and a method of detecting RSOs are provided. The method includes generating a foreground of the simulated image including RSOs by calculating coordinates of an imaging satellite at a given time, determining an area of interest given a field of view (FOV) of the imaging satellite, and calculating coordinates of all RSOs and saving the coordinates if the RSO is within the area of interest. The method further includes generating a background of the simulated image including stars by querying a star catalogue database for coordinates of all stars that fall inside the FOV, adding noise, and translating RSO and star coordinates to pixel coordinates. The method further includes generating the simulated image by choosing an imaging mode, setting an exposure time, and rendering the simulated image.

### TECHNICAL FIELD

The following relates generally to space situational awareness (SSA), and more particularly to systems and methods for detecting, classifying, and correlating resident space objects (RSOs) from optical payload platforms in space or on the ground.

### INTRODUCTION

Detecting and tracking RSOs with on-orbit payloads is increasingly crucial for the needs of future spacecraft navigation. Conventional methods are slow and often require a human operator to analyze downlinked or external data for SSA followed by tasking a ground or space asset to provide more observations to increase the tracking accuracy of the RSO. The ability to perform this task autonomously may shorten the response time of a ground-based decision support system and allow more detections to improve the overall RSO tracking accuracy. As the quantity of objects in orbit increases, so too do the risks from the decision support systems used to avoid unplanned collisions. Shortcomings with conventional SSA mean collisions with unseen debris or failures in probabilistic assessment of collision may continue and increase with the trends in the space environment.

Detecting, tracking, and classifying rendezvous proximity operator-type threats is further desirable for future spacecraft navigation. Rapid sensor cueing response from satellite to satellite is further desirable for future spacecraft navigation.

Accordingly, there is a need for an improved system and method for detecting and tracking RSOs that overcomes at least some of the disadvantages of existing systems and methods.

### SUMMARY

A method of generating a simulated image for training an image segmentation model to detect resident space objects (RSOs) is provided. The method includes generating a foreground of the simulated image, the foreground including RSOs, by calculating coordinates of an imaging satellite at a given time, determining an area of interest given a field of view (FOV) of the imaging satellite, and calculating coordinates of all RSOs and saving the coordinates if the RSO is within the area of interest, generating a background of the simulated image, the background including stars, by querying a star catalogue database for coordinates of all stars that fall inside the FOV, adding noise to the simulated image, and translating RSO and star coordinates to pixel coordinates in the simulated image, and generating the simulated image by choosing an imaging mode, setting an exposure time, and rendering the simulated image according to the imaging mode and the exposure time.

Calculating coordinates of all RSOs may be performed using a propagation algorithm.

The noise may include star streaks.

The imaging mode may be chosen from among sidereal tracking, target rate tracking, and a custom rate.

Calculating coordinates of all RSOs and saving the coordinates if the RSO is within the area of interest may include simulating orbit paths to generate a list of access windows when a foreground satellite is in the FOV.

Time stamps associated with each access window may be slightly randomized so that the foreground satellite may not always be centered in the simulated image.

Time stamps associated with each access window may be used to calculate right ascension (RA) and declination (DEC) of all foreground satellites in the FOV.

Translating the RSO to the pixel coordinates in the simulated image may be performed according to the RA and the DEC.

A method of training an image segmentation model to detect resident space objects (RSOs) is provided, the method including generating a training set by performing the method of generating a simulated image for a plurality of simulated images and training the image segmentation model using the training set and/or one or more real images.

The method may be performed on a low-power GPU or an FPGA.

A method of detecting resident space objects (RSOs) in an optical image is provided, the method including inputting the optical image to a trained image segmentation model trained using the method of training an image segmentation model, and detecting RSOs in the optical image using the trained image segmentation model.

A method of training an image segmentation model for detecting RSOs is provided, the method including generating a simulated training dataset, the simulated training dataset including at least one simulated training image, each simulated training image simulating a view from an imaging satellite or ground-based optical system, curating the simulated training dataset by performing one or more of customizing the simulated training dataset for edge cases, different sensor types, and/or different image satellites, and combining different simulated training datasets, processing the simulated training dataset into a training subset, a testing subset, and a validation subset, generating an RSO detection model by training a modified U-Net on the training subset, verifying the generated RSO detection model with the testing subset, and validating the generated RSO detection model by inputting the validation subset into plate-solving algorithms.

A method of detecting RSOs in an optical image is provided, the method including generating simulated training images using an image simulator, each of the simulated training images simulating a view from an imaging satellite or ground-based optical sensor and including a simulated foreground including RSOs and a simulated background including stars, training an RSO detection model using the simulated training images, configuring the trained RSO detection model for onboard processing, the onboard processing being onboard a satellite, and detecting RSOs in the optical image using the trained RSO detection model that has been configured for onboard processing.

The image simulator may apply a configurable scale of brightness that incorporates a pseudorandom element and generates a realistic brightness variation across the simulated training images, and the sizes of the RSOs in the simulated foreground may be randomized between 3 to 5 pixels in size.

A method of detecting RSOs onboard a satellite is provided, the method including acquiring an optical image using an optical sensor onboard the satellite, providing the optical image to a processor onboard the satellite, the processor executing an RSO detection model trained using a plurality of simulated training images simulating a view from an imaging satellite, each simulated training image including a simulated foreground including RSOs and a simulated background including stars, detecting RSOs in the optical image using the RSO detection model, and controlling an attitude of the satellite based on an output of the RSO detection model.

The method may be performed on a low-power GPU or an FPGA.

Provided is a method of generating a simulated image for training an image segmentation model to detect resident space objects (RSOs), the method including generating a foreground of the simulated image, the foreground including RSOs, by calculating coordinates of an imaging satellite at a given time, determining an area of interest given a field of view (FOV) of the imaging satellite, and calculating coordinates of all RSOs and saving the coordinates if the RSO is within the area of interest. The method further includes generating a background of the simulated image, the background including stars, by querying a star catalogue database for coordinates of all stars that fall inside the FOV, adding noise to the simulated image, and translating RSO and star coordinates to pixel coordinates in the simulated image. The method further includes generating the simulated image by choosing an imaging mode, setting an exposure time, and rendering the simulated image according to the imaging mode and the exposure time.

Provided is a method of training an image segmentation model to detect resident space objects (RSOs), the method including generating a training set by performing generating a simulated image as above in respect of a plurality of simulated images and training the image segmentation model using the training set.

Provided is a method of detecting resident space objects (RSOs) in an optical image, the method including inputting the optical image to a trained image segmentation model trained as above and detecting RSOs in the optical image using the trained image segmentation model.

Provided is a method of training an image segmentation model for detecting RSOs, the method including generating a simulated training dataset, the simulated training dataset including at least one simulated training image, each simulated training image simulating a view from an imaging satellite or ground-based optical system. The method further includes curating the simulated training dataset by performing one or more of customizing the simulated training dataset for edge cases, different sensor types, and/or different image satellites and combining different simulated training datasets. The method further includes processing the simulated training dataset into a training subset, a testing subset, and a validation subset. The method further includes generating an RSO detection model by training a modified U-Net convolutional neural network (CNN) on the training subset. The method further includes verifying the generated RSO detection model with the testing subset. The method further includes validating the generated RSO detection model by inputting the validation subset into plate-solving algorithms.

Provided is a method of detecting RSOs in an optical image, the method including generating simulated training images using an image simulator, each of the simulated training images simulating a view from an imaging satellite or ground based optical sensor and including a simulated foreground including RSOs and a simulated background including stars. The method further includes training an RSO detection model using the simulated training images. The method further includes configuring the trained RSO detection model for onboard processing, the onboard processing being onboard a satellite. The method further includes detecting RSOs in the optical image using the trained RSO detection model that has been configured for onboard processing.

Provided is a method of detecting RSOs onboard a satellite, the method including acquiring an optical image using an optical sensor onboard the satellite, providing the optical image to a processor onboard the satellite, the processor executing an RSO detection model trained using a plurality of simulated training images simulating a view from an imaging satellite, each simulated training image including a simulated foreground including RSOs and a simulated background including stars, detecting RSOs in the optical image using the RSO detection model, and controlling an attitude of the satellite based on an output of the RSO detection model.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a flow chart of a method for detecting RSOs, according to an embodiment;

FIG. 2 is a schematic diagram of a work cycle of an RSO detector implemented using a CNN, according to an embodiment;

FIG. 3 is a schematic diagram of a work cycle of the image simulator of FIG. 2, according to an embodiment;

FIG. 4 is a block diagram of a computer system for generating simulated images for training a machine learning model for detecting RSOs, according to an embodiment;

FIG. 5 is a flow chart of a method for generating simulated images for training a machine learning model for detecting RSOs, according to an embodiment;

FIG. 6 is a schematic diagram of a modified U-Net CNN for detecting RSOs, according to an embodiment;

FIG. 7 is a graph illustrating an effect of threshold on RSO detection by an RSO detection model, according to an embodiment;

FIG. 8 is a block diagram of a computer system for implementing the modified U-Net CNN of FIG. 6, according to an embodiment;

FIG. 9 is a flow chart of a method of implementing a trained RSO detection model on a GPU for onboard processing using the RSO detection model, according to an embodiment;

FIG. 10 is an example training image, truth mask, and prediction of a trained model, according to an embodiment;

FIG. 11 is a chart showing inference speed vs. GPU power mode and displaying findings based on the statistics of the varying power modes, according to an embodiment;

FIG. 12 is a chart displaying CPU maximal frequency vs. inference speed, according to an embodiment; and

FIG. 13 is a block diagram of a system for onboard RSO detection optical imagery, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, personal computer, single board computer, microcontroller, cloud-based program or system, laptop, personal data assistants, cellular telephone, smartphone, or tablet device.

Each program is preferably implemented in a high-level procedural or object-oriented programming and/or scripting language to communicate with a computer system. However, the programs may be implemented in assembly or machine language, if desired. In any case, the language may be a compiled or interpreted language. Each such computer program is preferably stored on a storage medium or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to detecting resident space objects (RSOs) in any orbital regime, and more particularly to training neural networks to detect RSOs for space situational awareness (SSA) using space-based and ground-based optical payloads and low-SWAP onboard processing (OBP) and detecting RSOs using a trained machine learning model. Orbital regimes may include any one or more of low Earth orbit (LEO), medium Earth orbit (MEO), geostationary orbit (GEO), high Earth orbit (HEO), cislunar, and deep space.

Advancements in machine learning (ML) enable spacecraft systems to perform their own detection and evaluation of collision hazards using onboard sensors. Rather than solely relying on ground-based manual evaluation of third-party data sources, a satellite can perform its own collision hazard identification and mitigation without human involvement, reducing risk of catastrophic collision and cost. The satellite may do so using a network of space situational awareness sensors. The systems and methods of the present disclosure may advantageously make the SSA sensor network smarter and increase the quality of an SSA observation to the network.

To address the challenges of SSA in crowded orbits, the present disclosure provides an ML model trained to detect the location of RSOs among a field of stars using optical imagery. This has been achieved in three parts: (1) the creation of an image simulator to generate large datasets of simulated satellite imagery; (2) the creation and training of a modified U-Net CNN and the resulting model; and (3) the deployment and optimization of the trained model on a low-SWAP GPU.

The training in (1) may further be performed with real images in addition to or instead of simulated satellite imagery.

The ability to simulate heterogeneous sensor types or non-nominal image data is desired, and thus a fully configurable image simulator is provided by the present disclosure. The ability to simulate different imaging modes with different exposure times, including sidereal, target rate tracking, and custom rate, is further provided by the present disclosure. The user of the image simulator may configure attributes such as the Field of View (FOV) and the image size to simulate a particular camera. For this endeavour, the simulator was configured to create synthetic imagery representative of a typical satellite mission, where actual payload data was available for verification. Additionally, the image simulator allows the user to specify attributes in the image, featuring various types of noise, dead pixels, and other common attributes found in on-orbit data to allow the user to emulate a wide variety of on-orbit optical sensors.

In an embodiment, once trained, a modified U-Net CNN model of the present disclosure detected the location of RSOs among a field of stars with an 83% accuracy. The trained model was then deployed onto the Nvidia Xavier Jetson AGX GPU. Optimization of throughput, power, efficiency, and inference time was achieved. Experimentation was conducted with different inference engines. The trained model could successfully predict the location of RSOs from optical data image within 23 ms.

The amount of space debris and satellites in orbit is increasing, making the on-board detection of Resident Space Objects (RSOs) ever more important for spacecraft situational awareness and collision mitigation. Doing so may include using a Space Situational Awareness (SSA) sensor network and collision mitigation. On-board, low-cost optical sensors are increasingly being used to produce image data for SSA. The ability to accurately interpret optical sensor image data for RSOs and propagate their orbits rapidly, for instance, is a fundamental building block for applications like automated flight dynamics for collision avoidance.

In an embodiment, the neural network-based model of the present disclosure extracts the position information for RSOs in optical images of star streaks and is trained with simulated images based on an existing, space heritage, SSA optical payload. Verification of the model was based on the proximity of predicted RSOs to the position of the truth mask RSOs. The model was able to achieve 83% accuracy with fully simulated on-orbit data. Two-thirds of the detection errors are attributed to missed RSOs and one third attributed to false positives. Detection performance improved when reducing features associated with non-nominal image data, suggesting that broader on-orbit optical image datasets and greater temporal coverage would improve model accuracy. The trained model was then run on a configurable Graphical Processing Unit (GPU) in an effort to mimic a space qualified System on Chip (SoC), making RSO location predictions within 23 ms.

The success of the trained model demonstrates that the present disclosure is suitable for closed-loop applications such as automated flight control and other time-critical operations. This capability may prove to be key when integrated with an onboard SSA system. In some cases, a network of sensors may be used to predict in advance impending collisions. Further, automated flight control can be slow and a predictive warning may be needed to allow flight control to react.

Other efforts in the space community have trained ML models using existing and available payload data using ground infrastructure. The ability to have closed-loop RSO detection, classification, orbit determination, and maintenance onboard the payload may advantageously enable applications involving automated remote proximity operations (RPO) such as detecting, tracking, and classifying, tasking (tipping and cueing and optimization), and information production to support a real-time concept of operations for SSA.

Advantageously, relative to existing technologies, the present disclosure permits production of application-specific ML models to enhance the performance of algorithms depending on the characteristics needed for a given application.

The on-board detection of RSOs and their classification is a key emerging strategic theme in the spaceflight industry and related industries. This ability to detect RSOs will be important for any automated flight dynamics, in particular for the next generations of space based optical missions.

The present disclosure includes an image simulator to generate large datasets of simulated satellite imagery.

The present disclosure further includes a neural network (preferably a U-Net convolutional neural network (CNN) algorithm) that, upon training and/or modification, generates or outputs a model. The neural network may be any suitable neural network, particularly any suitable CNN.

The present disclosure further includes deployment and optimization of the trained model on a low-power GPU.

The present disclosure may have further applications in the use of the foregoing CNN for generating models and the models generated thereby for, in an example, finding patterns or making decisions from a previously unseen dataset in a broader SSA system to leverage the foregoing capabilities for an on-orbit decision making algorithm, system, method, and/or device.

Although a CNN is discussed as a preferred embodiment of the neural network for training the model, it will be appreciated that other neural networks are expressly contemplated in the present disclosure.

Other technical apparatus or software abstractions for training models and/or for image segmentation are expressly contemplated herein.

The systems, methods, and devices for SSA OBP according to the present disclosure may generate simulated images for training a CNN model, which may be a U-Net model, more efficiently (through fewer parameters) and more quickly (through the use of the simulated images instead of waiting for an adequate number of real images) than conventional systems, methods, and devices.

The deployment and optimization of such a trained U-Net model in a low-power GPU context may advantageously render the present systems, methods, and devices more suitable for SSA OBP than conventional systems, methods, and devices.

Specifically, spacecraft and the design, development, and deployment of same are known to be extremely expensive endeavours, and any additional weight in a spacecraft may drastically increase the cost of launching the spacecraft.

Accordingly, it is desirable to keep the size, weight, and power (SWaP) of the spacecraft as small as possible, which makes the use of high-powered computers disadvantageous, as such high-powered computers increase the SWAP of the spacecraft.

Furthermore, as the power budget on spacecraft may be very low, it is highly desirable to perform inferences using a low-powered graphics processing unit (GPU) or field programmable gate array (FPGA), which is further provided by the present disclosure. Accordingly, the foregoing models implemented on such low-powered GPUs may be feasible for space applications as they may advantageously be performed very quickly on a low-power device or on a very low-power mode.

Therefore, deploying and optimizing the foregoing trained U-Net model in the low-power GPU context may present further advantages in terms of cost savings and feasibility.

The systems, methods, and devices for SSA OBP according to the present disclosure include a series of artificial intelligence software modules developed for the purposes of detecting, classifying, and correlating RSOs from optical payload platforms in space or on the ground.

The software modules utilize neural networks (such as CNNs) to optimize performance against the characteristics of the application or the input data.

A novel use of an image simulator was developed to support the machine learning requirements to do so.

A space-based sensor, for example, is simulated with the introduction of the sensor's noise, sky noise, light gradients, star streaks, and reference images of RSOs.

Artificial intelligence (AI) software is used for image interpretation and as inputs to flight dynamics, tasking, or processing sub-routines. The foregoing is optimized for space hardware.

Detecting, classifying, and maintaining orbit information of RSOs is known to be a very difficult problem to solve. The generation and use of synthesized images to train AI models to detect the location of RSOs in optical imagery, classify the RSOs, and determine orbits thereof represents a significant advancement in the field of SSA. Moreover, an advantage of the foregoing is the use of low-power GPUs or FPGAs to enable this new approach.

The present disclosure includes tuning an AI classifier to work in a low-SWaP computing environment. Conventional implementations of AI for SSA are focused on ground segment or high-powered GPUs which are not accessible for space missions for reasons of cost and power.

Accuracy of orbits calculated in the image simulator has been verified according to third-party software for simulating orbit paths (e.g., Systems Tool Kit (STK)). Accuracy of the position and/or movement of stars in the background of the simulated images has been obtained by feeding the simulated images to plate-solving algorithms and receiving the correct coordinates. Comparison of the resulting images to real satellite images has further verified accuracy.

The accuracy of the ML model has been further verified using training graphs and a testing dataset and observing the results.

The present application relates to a system and method using ML to detect RSOs among a field of stars. A model may be trained on custom-generated simulated images and/or real images. Features may be added iteratively to the images, enabling the tuning of datasets with the desired features, ensuring their likeness to real imagery.

In an embodiment, the structure of the model relates to the Deeptrack 2.0 U-Net model. Adjustments and optimizations to the original CNN's construction were made. Various datasets were used as training inputs, including various epochs, batch sizes, penalties, and loss functions. Once the accuracy results were satisfactory, the model was run on the GPU, and the resulting performance data was recorded.

Given the customizable nature of parameters such as imaging mode and exposure time, images can be generated in likeness to any optical sensor.

A particular advantage of the present systems, methods, and disclosures includes the autonomous nature of detecting RSOs using only satellite or in-space components without reliance on ground-based components. Specifically, upon detecting the RSO's, subsequent action(s) may be taken (e.g., by sensors on the detecting satellite or on other satellites) based on the information generated through the RSO detection. Such subsequent action may be planned or tasked (e.g., an instruction for a sensor to perform a particular functionality, such as tracking the RSO) and executed (e.g., physically tracking the RSO) in an autonomous manner.

The present disclosure further relates to a smart space sensor capable of taking autonomous action to cue another payload sensor or another satellite (with high resolution optics or a hyperspectral sensor) or to continue tracking the RSO. Such capability is autonomous and may be performed at or by the smart space sensor without a ground centralised control.

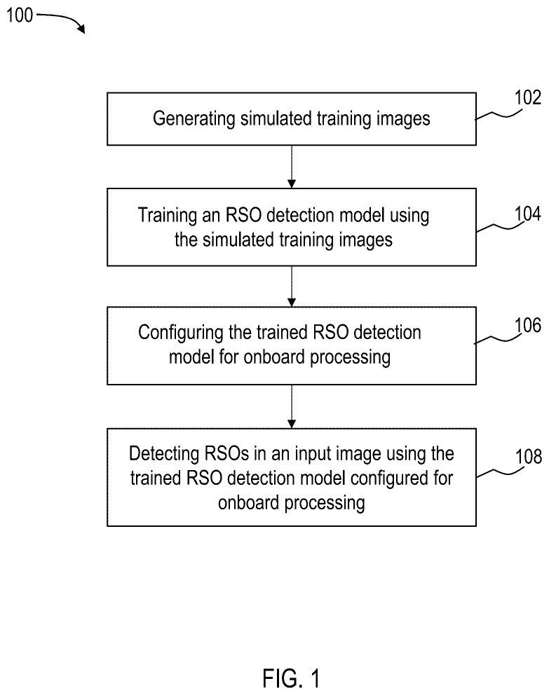

Referring now to FIG. 1, shown therein is a method 100 of detecting RSOs, according to an embodiment. The method 100 is executed using a computer system or equivalent such as a field programmable gate array (FPGA) or an application-specific integrated circuit (ASIC). The computer system may include one or more computing devices each comprising a processor and a memory. The method 100 may be stored in memory as computer-executable instructions and executed by the processor.

The method 100 may be executed using any suitable type of computing device. Aspects of the method, such as inference, may be implemented on low-power hardware, such as a low-power GPU or an FPGA.

At 102, the method 100 includes generating simulated training images using an image simulator.

At 104, the method 100 includes training an RSO detection model using the simulated training images. The RSO detection model is a machine learning model. The RSO detection model may be a neural network-based model.

At 106, the method 100 includes configuring the trained RSO detection model for onboard processing.

At 108, the method 100 includes detecting RSOs in an input image using the trained RSO detection model configured for onboard processing. The trained RSO detection model may be set up or configured to run inference on low-power hardware such as a low-power GPU or FPGA.

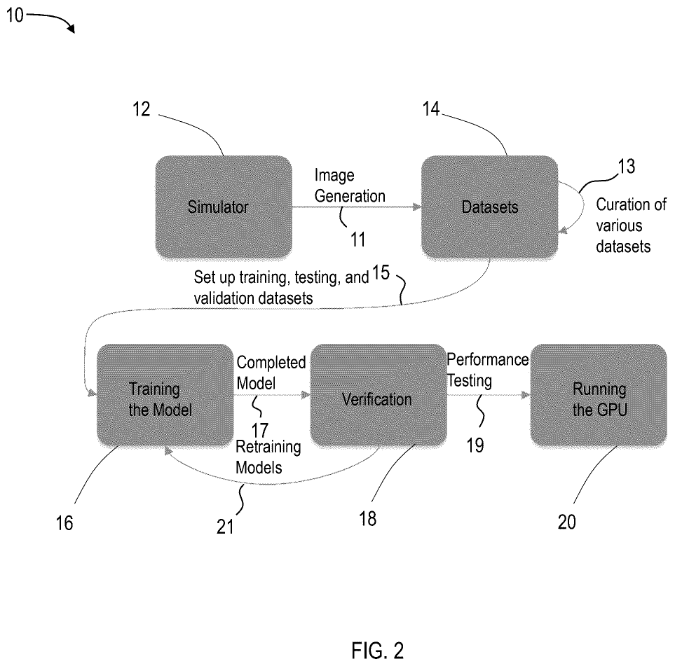

Referring now to FIG. 2, shown therein is a pipeline 10 for generating and using an RSO detector implemented in a CNN, according to an embodiment. The CNN may be a U-Net. It will be appreciated that the RSO detector may be implemented in, by, or with neural networks other than a CNN or by image segmentation models other than a neural network. The RSO detector may be a semantic segmentation model.

In some cases, some subset of the elements of pipeline 10 may be performed on ground using one or more computer systems. In variations, the subset may vary. Such elements executed on ground may run without a SWAP issue. In an embodiment, elements of pipeline 10 leading to the generation of completed model/final dataset 17 are performed on ground (i.e., without a SWAP issue) and the completed model/final dataset 17 is sent to the satellite and elements performed thereafter are adapted to meet SWaP constraints.

In an embodiment, the RSO detector is run on a GPU (e.g., see GPU 20, below).

The pipeline 10 is executed by a computer system or an FPGA equivalent implementation, including a processor and memory.

The pipeline 10 includes an image simulator 12. The image simulator 12 is stored in the memory and executed by the processor. The image simulator 12 is configured to perform an image generation operation 11 to obtain simulated training datasets 14. The datasets 14 are stored in memory.

The image simulator 12 produces as the simulated training datasets 14 images akin to the view from the imaging satellite.

The simulated training datasets 14 include the presence of RSOs on a background of photorealistic stars.

The simulated training datasets 14 may be generated according to the method 100 of FIG. 1 at 102.

An image is rendered with representations of RSOs and stars to imitate the perspective of a camera on an image satellite or ground-based optical sensor at a given time. The rendered image is representational of what would physically be seen had an image actually been taken at that time and location.

Once the positions of the RSOs and the stars are calculated, noise is added.

In an embodiment, a selection of satellites may serve as RSO targets (e.g., a selection of GEO satellites). Orbits may be propagated in the simulated training datasets 14.

In pipeline 10, once generated the simulated training datasets 14 are curated at 13. The simulator 12 advantageously provides substantial flexibility in the curation of the datasets 14, allowing customization for edge cases, different sensor types, different optical systems, etc.

The pipeline 10 may generate a plurality of datasets that highlight different features, some with more specific differences than others depending upon reasons, goals, or targets for training the model. For example, there may be provided a dataset where all “stars” were significantly dimmer than in a baseline set. In a further example, there may be provided a dataset where the star streaks were longer or shorter than in a baseline set. Images from several datasets may be taken or combined to create the simulated training datasets 14.

At 15, the curated datasets 14 are processed to set up training, testing, and validation datasets.

Because the curated datasets 14 are very similar to data as taken by real satellites, the pipeline 10 includes an RSO detector machine learning model training operation at 16. The model is trained using the curated datasets 14. Training the model 16 may occur according to the method 100 of FIG. 1 at 104.

Model training at 16 generates a completed model as output at 17, which is provided as input to a verification operation 18.

If the verification operation 18 is unsuccessful, a retraining operation 19 is initiated. Retraining is performed using the model training operation 16.

The work cycle 10 includes verification of the model at 18 to produce a verified model, if verification is successful. If verification of the model at 18 is unsuccessful, the model 16 is retrained.

The verification operation 18 generates a verified model. The verified model is performance tested 21 by running a graphics processing unit (GPU) 20 on the basis of the trained model 16 as verified at 18.

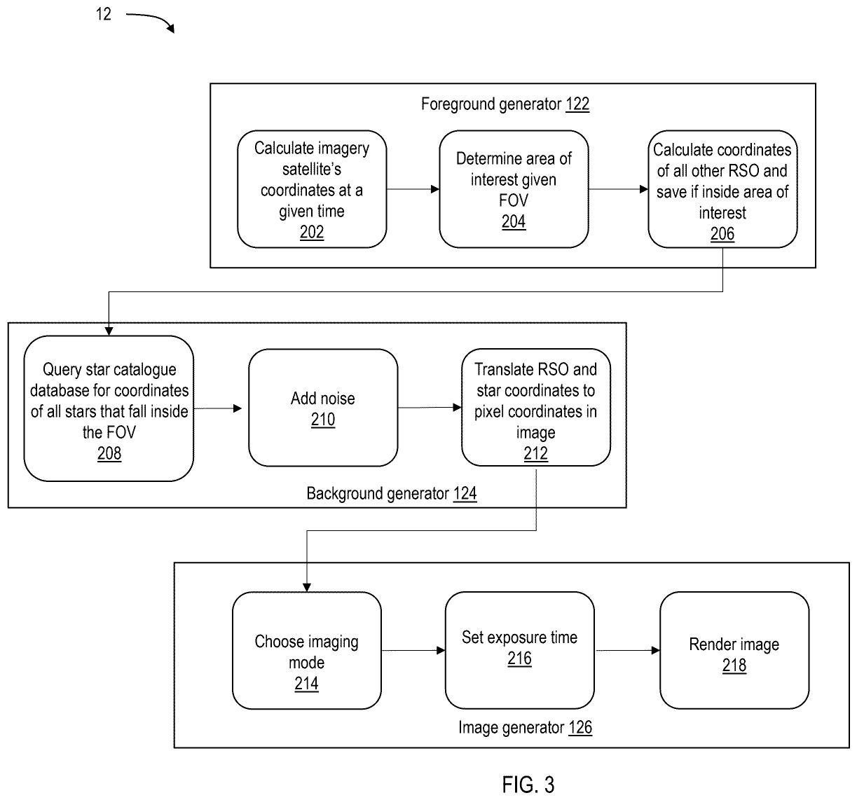

Referring now to FIG. 3, shown therein is the image simulator 12 of FIG. 2 in further detail, according to an embodiment.

The image simulator 12 includes a foreground generator 122 for generating a foreground of the simulated training datasets 14.

The image simulator 12 further includes a background generator 124 for generating a background of the simulated training datasets 14.

The image simulator also includes an image generator 126.

At 202, the foreground generator 122 calculates coordinates of an imagery satellite at a given time. The coordinates of an imagery satellite are calculated using a propagation algorithm (e.g., Simplified General Perturbations 4 (SGP4)).

At 204, the foreground generator 122 determines an area of interest given a field of view (FOV) of the imagery satellite at the given time. For a specific FOV and area of interest, when the information of where the satellite is pointing is known at a given point of time, a database of star positions may be consulted to find the area. When the coordinates of the image satellite are known, its FOV is calculated using trigonometry.

At 206, the foreground generator 122 calculates coordinates of all other RSOs and saves those RSOs inside the area of interest.

At 208, the background generator 124 queries a database for coordinates of all stars that fall inside the FOV. For example, the database may be the Tycho2 database, which is a public data base storing star coordinates, brightness, and other stellar information.

At 210, the background generator 124 adds noise to the simulated training dataset 14. Various types of noise may be added, for example through applying a Gaussian noise function through Python. Other exemplary noise includes star streaks. Star streaks may be added by drawing streaks on either side of the current location of a star.

At 212, the background generator 124 translates coordinates of RSOs and stars to pixel coordinates in the simulated training dataset 14. The translation may be performed through a mapping function.

At 214, the image generator 126 chooses an imaging mode from among sidereal tracking, target rate tracking, and a custom rate.

At 216, the image generator 126 sets an exposure time of the image to be rendered.

At 218, the image generator 126 renders the image. The image may be rendered through Image.render, a built-in function in Python.

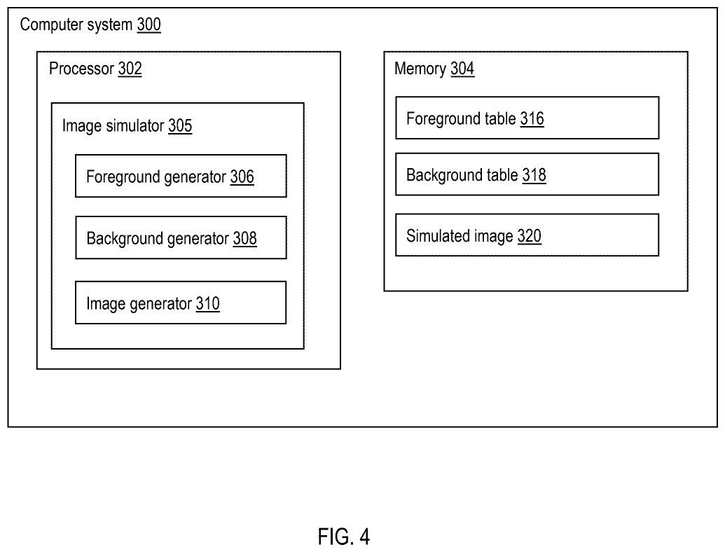

Referring now to FIG. 4, shown therein is a computer system 300, according to an embodiment.

The computer system 300 includes a processor 302 for executing software models and modules.

The computer system 300 further includes a memory for storing data, including data output from the processor 302 and a simulated image 320.

The processor 302 is configured to execute an image simulator 305. The image simulator 305 may be the image simulator 12 of FIG. 1.

The image simulator 305 includes a foreground generator module 306, a background generator module 308, and an image generator module 310.

The foreground generator 306 is configured to generate a foreground of simulated training datasets.

The foreground generator 306 calculates positions of all initialized satellites and draws the satellites in the correct position at a given time. In order to do so, an image satellite is initialized. Using visualization software configured to simulate orbit paths (e.g., STK), a list of access windows is generated. These access windows are times when the foreground satellites are in the FOV of the image satellite.

As access windows are finite (STK only generates time stamps for when an object is in the FOV), time stamps are slightly randomized.

Such randomization advantageously ensures that the satellites were not always centered in the image whose foreground is produced by the foreground generator 306.

Such randomization further advantageously provides for the expansion of the dataset for training, validation, and testing.

The foreground generator 306 takes a time stamp and calculates the right ascension (RA) and declination (DEC) of all initialized satellites at the given time.

The RA and DEC of the image satellite is set to be the center of the image generated. All other satellite's RA and DECs are also calculated at the given time.

The real-world RA and DEC coordinates are transformed to pixel coordinates used to render the image.

These data points are stored in a foreground table 316 to be combined with a background table 318 populated by a background generator 308. The foreground table 316 and the background table 318 are stored in memory 304.

It is also important to note that the size of the simulated image is specified to match the size of the image of the camera of the satellite on which a model trained by the simulated image will be deployed. Pixel coordinate entries are calculated for all satellites, then saved to be rendered in the final image if they lie inside FOV.

The foreground generator 306 uses accurate orbital information to project all satellites into their correct position in the frame of the simulated image 320.

Using an analytical or numerical propagator or propagation scheme, classical orbital elements of each satellite are leveraged to determine its coordinates given a timestamp. In an embodiment, the propagation scheme is SPG4. Any suitable analytical or numerical propagator or propagation scheme may be used.

The image simulator 305, and in particular the foreground generator 306, propagates the image satellite and uses a configurable FOV angle attribute of the image satellite to determine the area of the sky that the satellite would be able to “see” at the given time.

All other initialized satellites are propagated to determine their respective RA and DEC coordinates.

Where foreground satellites fall in the FOV of the image satellite, coordinates of the foreground satellites are inputted into the rendered image.

To create the illusion of varying brightness in RSOs and stars due to distance, relative light emission levels, and reflective and refractive properties, a configurable scale of brightness is applied by the foreground generator 306 that incorporates a pseudorandom element and generates a realistic brightness variation across the entire simulated image 320. A brightness parameter may be extracted from a star catalog, such as Tycho2 under the magnitude of the “brightness” of a star or celestial object in the green part of the visible light spectrum, i.e., Gmag. Random brightness may further be used. Where random brightness is used, it may be advantageous not to provide many bright, saturated stars, which may affect astrometry.

The sizes of RSOs drawn on the simulated image 320 are randomized between 3 to 5 pixels in size to best represent reference data.

Additionally, the brightness is randomized. In an embodiment, the brightness is randomized between apparent magnitude 9 and apparent magnitude 14. Apparent magnitude is a logarithmic astronomical measurement referring to apparent brightness of a star, as opposed to absolute brightness. For example, a star may be very bright compared to the Sun but may be so far away as to appear dim.

Referring again to image simulator 305, the background generator 308 is configured to draw a field of stars in the background of the simulated training dataset, i.e., behind the RSOs.

The background generator 308 queries a star database for all stars that fall in the FOV of the image satellite given its current RA and DEC. The star database is stored in memory 304. The FOV of the image satellite is specified in a configuration file thereof, e.g., 1.4°.

The background generator 308 further converts the RA and DECs of the stars that fall within the FOV radius to pixel coordinates.

The background generator 308 further stores the pixel coordinates in the background table 318.

The background generator 308 generates the starry background of the simulated image 320.

Leveraging the background table 318, which includes the positions of stars in the sky, a background portion of the simulated image 320 is populated with the exact stars that would fall into the FOV of the image satellite given its coordinates at the specified time.

All the coordinates of the stars that fall within the view of the image satellite payload (i.e., camera) are collected and stored in the background table 318.

Using the same process in place for the foreground satellite coordinates, the star coordinates are transformed from RA and DEC positions into pixel coordinates in the simulated image 320.

Once the background portion of the simulated image 320 is rendered, the accuracy of the background portion of the simulated image 320 may be validated using plate solving algorithms, which were successfully able to determine the portion of the night sky rendered.

In an embodiment, the database is the Tycho2 database including the positions of the 2.5 million brightest stars in the sky.

The image simulator 305 creates simulated satellite imagery. The image simulator 305 produces images akin to the view from the imaging satellite, complete with the presence of a known RSO on a background of photorealistic stars. In an embodiment, the image simulator 305 is written in Python.

In an embodiment, a selection of satellites (e.g., GEO satellites) serve as the RSO targets. The image simulator 305 advantageously provides ample flexibility in the curation of the simulated training dataset 14 of FIG. 2 to permit customization for any one or more of edge cases, different sensor types, different image satellites, etc. to train AI models.

Advantageously, the image simulator 305 is able to generate images of customizable satellites (e.g., GEO satellites) that would be in the Field of View (FOV) of an image satellite (e.g., in LEO) at any given time. The image simulator 305 may generate images of any suitable satellite that would be in the FOV of an image satellite in a lower orbit. The orbit propagations are all accurate. The higher-orbit satellites are drawn on the image at the accurate location in the simulated image 320 output by the processor 302.

The image simulator 305 further queries a star database (e.g., the Tycho2 database) to fill in all stars that fall within the LEO's FOV at the given time.

To make these images as realistic as possible, several customizable noise and distortion methods have been implemented, including star streaking to simulate an open aperture during the high speeds of an orbit.

In order that the simulated image 320 resembles real satellite images as closely as possible, the image simulator 305 provides several configurable features for customizing the simulated image 320.

The image simulator 305 may implement Gaussian Noise on the RSOs and stars. The resulting effect is a blur of the edges of both features, similar to what one might see in a real image.

The image simulator 305 may implement diffraction spikes, e.g., as seen in a reflector or Cassegrain telescope system.

The image simulator 305 may further implement background noise on the black space of the background of the simulated image 320.

The background noise simulates camera defects, light in the sky, and hot and dead pixels. The background noise may be visible as a faint, fuzzy grey in the background of the images. A user of the computer system 300 may be able to selectively engage or disengage the background noise feature.

The image simulator 305, in order to simulate the effect of an open aperture on a camera during an orbit, may provide for visual effects in the simulated image 320.

Such visual effects include streaking the background stars. Streaking is achieved by rolling the background table 318 forwards and backwards through time and overlaying the resulting images in the simulated image 320. A user of the image simulator 305 may be able to selectively engage or disengage the streaking feature.

In reality, if an RSO is directly on top of a background star from the perspective of a camera of the image satellite, the RSO is not visible. Similarly, if a foreground star is directly on top of a background star from the perspective of the camera, the background star is not visible.

Accordingly, a further visual effect available in the image simulator 300 is the removal of any such overlap in the simulated image 320. Such removal of overlap occurs by checking the pixel coordinates of stars in the background table 318 against the pixel coordinates of RSOs and stars in the foreground table 316.

In the case of overlap between a foreground star and a background star (or even where the stars are sufficiently close from the perspective of the camera), the overlapping background star is not drawn in the simulated image 320.

In the case of overlap between a foreground RSO and a background star, the overlapping foreground RSO is not drawn in the simulated image 320.

If star streaking is enabled, all pixels where the star streak would be drawn are checked, and if there is an overlap anywhere in the streak, the entire star is not drawn.

A user of the computer system 300 may be able to selectively engage or disengage the removal of overlap feature.

An interesting feature implemented in the background generator is the removal of background stars that would be drawn on an RSO. In real world scenarios, an RSO directly aligned with a star would be undetectable. In operational circumstances, a series of multiple frames would likely be analyzed, allowing the RSO to move and become clearly visible once more. This feature eased the future training of the model, without compromising the probable operational flow. Alternately, the star or star streak that would otherwise obscure the RSO may not be drawn so as to allow for detection of the RSO.

The image simulator 305 may generate images with a random number of RSOs in random locations on random backgrounds. A user of the computer system 300 may be able to selectively engage or disengage the foregoing random generation feature.

Referring again to the image simulator 305, the image generator 310 is configured to generate the simulated image 320.

The image generator 310 generates the simulated image 320 by appending the background table 318 to the foreground table 316 and drawing the result.

Where further visual effects are to be incorporated in the simulated image 320, the image generator 310 applies those visual effects.

To validate the correctness of orbit calculations based on the simulated image 320, calculations based thereon were compared with a generated list of coordinates from STK.

To validate the correctness of the positions of the background stars in the simulated image 320, fully rendered simulated images 320 were fed into plate solving algorithms. The plate solving algorithms returned the calculated coordinates of the image satellite, which corresponds to coordinates of the center of the simulated image 320. Plate solving algorithms are used to determine which part of the night sky is being viewed by triangulating the detected stars and recognizing a pattern based on a database. Astronomers feed images from telescopes to these algorithms to determine where in the night sky they are examining. The foregoing demonstrates the accuracy of the simulated image 320 by proving that the positioning of the stars in the simulated image 320 is representative of the actual night sky.

The visualization software for simulating orbit paths (e.g., STK) was utilized to validate the position of all RSOs in the simulated images 320 generated by the system 300.

In STK, a simulation was built of all satellites propagated by the foreground generator 306, including all satellites used in the simulated images 320.

Access windows representing times in which a satellite fell within the FOV were calculated. The associated time stamps were used to generate the simulated images 320.

STK's propagator was further used to validate the accuracy of the Python propagator used in the image simulator 320 to calculate RSO coordinates.

In order to simulate on-orbit or non-earth imagery, a variety of noise attributes were added.

Initially, the image simulator 300 generated RSOs and stars as two-dimensional circles with high contrast between the objects themselves and the dark space of the background.

The resulting imagery could be likened to a black picture with white polka dots.

As this is not representative of the source imagery, a time dilation was added to simulate a realistic camera shutter speed and introduce noise that would be similar to conditions faced by a Low Earth Orbit (LEO) satellite.

This addition ensured that the stars in the background appeared as streaks instead of symmetrical circles.

The noise profiles added were multi-staged.

The foreground has Gaussian noise added to ‘soften’ the edges of the RSOs.

The background has Gaussian noise added to simulate Background Cosmic Radiation and to ‘soften’ the edges of the star streaks present. In addition, functionality was provided for adding hot and dead pixels, which represent an undesirable but common occurrence in image capture devices.

Hot pixels are characterized by being always on, and dead pixels are always off.

All this noise, time dilation and pixel options are configurable except for the noise added to the RSOs.

RSOs may appear to have a ‘soft’ edge regardless of the imaging device, but the remaining noise may be dampened by newer, more sophisticated noise dampening techniques and radiation hardening.

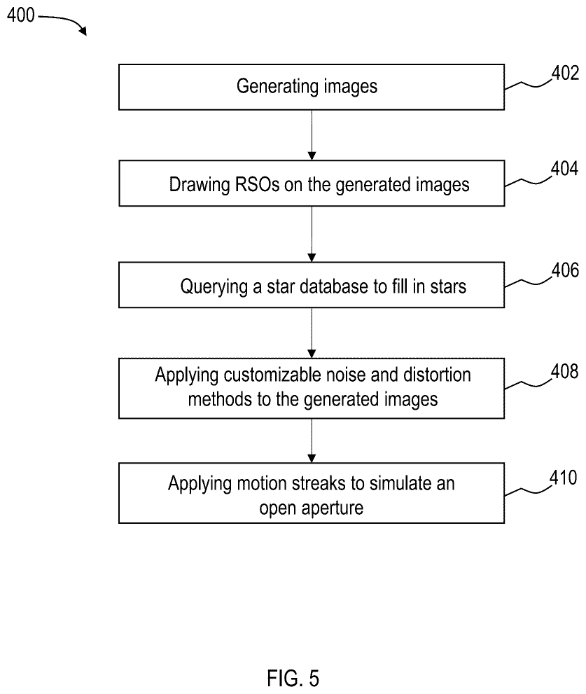

Referring now to FIG. 5, shown therein is a flow chart of a method 400 for generating simulated images to be used as training images for training an RSO detection model, according to an embodiment.

The method 400 may be suitable for training a U-net or other CNN-based model. The method 400 may be executed by the computer system 300 of FIG. 4. The method 400 may generate the simulated images 320 of FIG. 4. The method 400 may generate the simulated images according to the method 100 of FIG. 1 at 102.

At 402, the method 400 includes generating images (e.g., the datasets 14 of the pipeline 10 of FIG. 2) to be used for training the model.

At 404, the method 400 includes drawing any satellite that flies higher than the imaging satellite on the generated images in an accurate location. This may include drawing images of satellites in various orbital regimes that would be in the Field of View (FOV) of a Low Earth Orbit (LEO) imagery satellite at any given time.

At 406, the method 400 includes querying a star database to fill in all stars that fall within the LEO satellite's FOV in the generated images.

At 408, the method 400 includes applying customizable noise and distortion methods to the generated images. Such noise and distortion methods may advantageously make the generated images as realistic as possible.

At 410, the method 400 includes applying star streaking to simulate an open aperture during high speeds of an orbit of the LEO imagery satellite.

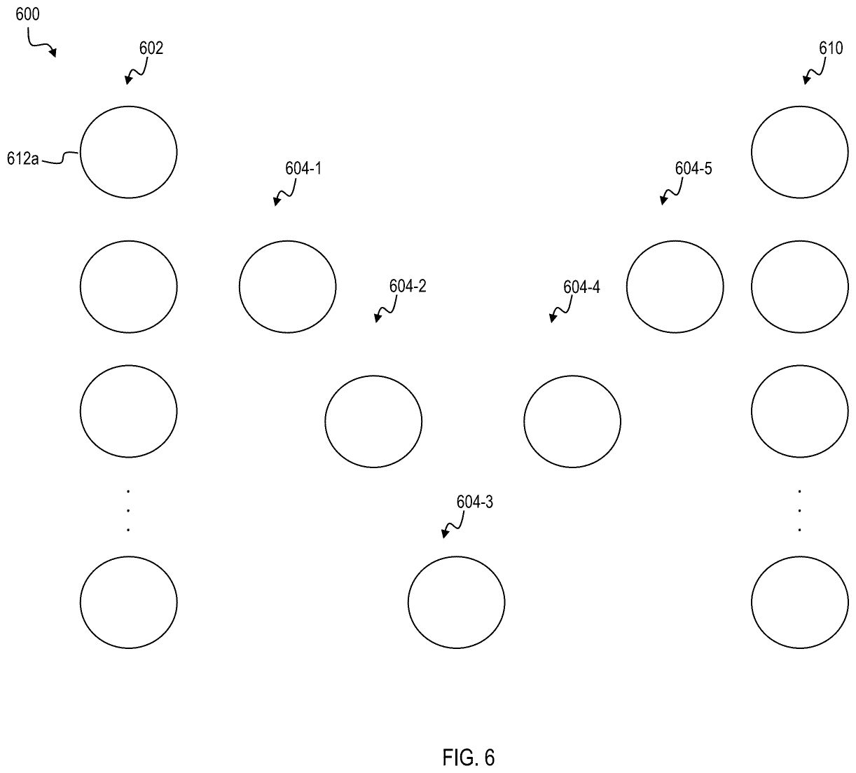

Referring now to FIG. 6, shown therein is a schematic diagram of a modified U-Net CNN segmentation model 600 for detecting RSOs, according to an embodiment.

A U-Net model 600 is trained to detect RSOs.

The U-Net 600 may use the simulated images 320 generated by the image simulator 300 of FIG. 4 to train the model to detect RSOs.

The U-net 600 includes a plurality of processing nodes 612 corresponding to sigmoid functions and configured in a plurality of layers including an input layer 602, at least one hidden layer, and an output layer having at least one output node.

The U-Net 600 includes an input layer 602 for receiving input to the U-Net 600. The input may be one or more simulated images 320.

The U-Net 600 further includes hidden layers 604-1, 604-2, 604-3, 604-4, 604-5 for processing the output of the input layer 602. It will be appreciated that any number of hidden layers may be provided.

The hidden layers 604-1, 604-2, 604-3, 604-4, 604-5 are hidden in that details of the processing are not known or shown outside the U-Net 600.

As indicated in FIG. 6, there may be any number of hidden layers 604-1, 604-2, 604-3, 604-4, 604-5.

The U-Net 600 further includes an output layer 610 for receiving the output of the hidden layers 604-1, 604-2, 604-3, 604-4, 604-5 and generating an output. The output may be an output segmentation map.

In an embodiment, the output of the U-Net 600 is the trained model. The trained model may be an arrangement or instantiation of the U-Net 600. The trained model may be a set of parameters or other values provided to the U-Net 600 as input or otherwise used to define or alter the U-Net 600 to affect or effect the trained model or otherwise.

The U-Net 600 is a convolutional neural network (CNN) whose architecture advantageously provides for fast and precise segmentation of input images (e.g., the simulated images 320) through modification and extension.

The U-Net 600 according to the modified and extended architecture advantageously trains the model with less input (e.g., fewer simulated images 320 provided as training images).

The model when trained yields more precise segmentations of input (e.g., of a simulated image 320).

When implemented on a modern graphics processing unit (GPU), segmentation of a 512×512 image through the modified U-Net model 600 may take less than a second.

The modified U-Net 600 supplements a conventional CNN with successive layers (e.g., more hidden layers 604).

Pooling operations of a conventional CNN are replaced by upsampling operators.

Each successive hidden layer 604-1, 604-2, 604-3, 604-4, 604-5 learns to assemble a precise output based on the output of the previous layers. Accordingly, a greater number of layers advantageously increases the resolution of the trained model.

One of the foregoing modifications applied to the architecture to generate the U-Net 600 is a large number of feature channels in the upsampling operators for allowing the U-Net 600 to propagate context information to higher-resolution layers.

Accordingly, an expansive path of the U-Net 600 is more or less symmetric to a contracting portion of the U-Net 600.

The U-Net 600 only uses the valid part of each convolution without any fully-connected layers, as a tiling strategy.

To predict the pixels in the border region of the simulated image 320, the missing context is extrapolated by mirroring the simulated image 320 as input.

The foregoing tiling strategy advantageously assists the U-Net 600 in processing large images, without which strategy resolution thereof may disadvantageously be limited by memory of the GPU.

Accordingly, the foregoing tiling strategy advantageously enables implementation of the U-Net 600 on a low-power GPU.

The U-Net 600 includes a contracting path and an expansive path (not shown).

Together the contracting and expansive paths provide the u-shaped architecture.

The contracting path includes repeated application of convolutions, each followed by a rectified linear unit (ReLU) and a max pooling operation. During the contracting path, the spatial information is reduced while feature information is increased.

The expansive path combines the feature and spatial information through a sequence of up-convolutions and concatenations with high-resolution features from the contracting path.

In an embodiment, the architecture of the RSO Detector Convolutional Neural Network (CNN) 600 was constructed with Tensorflow 2.6.2 and Keras 2.6.0 layers using Python 3.6. The basis of the model is from the DeepTrack 2.0 U-Net Model. The U-Net 600, or model trained thereon, has proven to successfully identify small clusters of pixels in an image, which is critical to detect RSOs. While a conventional U-Net model may have on the order of 31,000,000 trainable parameters, the modified U-Net 600 in an embodiment has 46,898, a reduction of 99.8%. Advantageously, the modified U-Net 600 incorporates a significant reduction of nodes. Such a reduction not only speeds up the training process but further improves onboard performance of the model. Furthermore, the reduction allows the training to devote more attention to the remaining weights. The convolution and convolution transpose layers are used to determine the location of RSOs in an input image provided to the input layer 602. The model is compiled using the “Adam” optimizer, the main metric being “accuracy,” and the loss function being the tensorflow_addons.losses. SigmoidFocalCrossEntropy ( ).

The modified U-Net 600 includes a SigmoidFocalCrossEntropy loss function. Such focal loss functions are better suited for imbalanced datasets such as images of space including RSOs. Even with eight RSOs present in the image, it was seen that 99% or more of the pixels are not RSOs, but rather star streaks or background. Such a large imbalance is partially compensated for by the focal loss function, as the focal loss function considers the imbalance when training the model, leading to better weight values during training.

### Testing and Experimentation

An embodiment of the RSO detector model of the present disclosure was trained with the simulated images 320. The final model saw 3484 images, 2800 of which were used in training, and the rest used in validation per epoch. A batch size of 32 was used during the run of 25 epochs. The model was then tested against other datasets. All images were 256×256 grayscale PNG files to save space and training time, without compromising on information captured in the image. Star streak length and direction, background noise, and quantity of RSOs differed between images to create a varied dataset. The aforementioned dataset size balanced the need for sufficient training data while avoiding overfitting. The selection of batch size and quantity of epochs was also a result of iterative investigations. Below 20 epochs, the model failed to predict consistently. When provided with more than 25 epochs showed at best marginal improvements, or led to overfitting.

Overfitting and underfitting are both issues relevant to models in machine learning. The sets of images used to train the model were developed so that each had a varying number of details that would provide enough unique or differing variables that the training would not begin to focus in on the details. Non-exhaustive examples of overfitting that were encountered during this project, and mitigated, include the following: streaks always in one orientation, the same length and thickness; all RSOs being a certain brightness, or always brighter than the stars; and a fixed amount of RSOs being present in the image, or the fact that an RSO is guaranteed to be present in an image.

The foregoing issues were mitigated via introducing new training data with newly randomized details to prevent all the images from having similar features.

Traditionally, F1 and intersection over union (“IoU”) scores are used to calculate accuracy of a model. Due to the imbalanced nature of the datasets, a method hinging on the quantity of object pixels vs. non-object pixels did not produce representative results of prediction accuracy. Given the small size of RSOs in the simulated images 320 (in terms of number of pixels representing an RSO), the distance between the center of the truth mask RSOs and the predicted RSOs was deemed to provide a more representative metric. In machine learning, a truth mask refers to a Boolean mask that indicates the ground truth values for a specific task. In image segmentation, a truth mask is a binary image where each pixel is labeled as either belonging to the object of interest or not. In this case, the truth mask is an image that describes whether each pixel is an RSO pixel or not. This mask serves as the reference or ground truth against which the model's predictions are evaluated.

The center of each pixel cluster in either image was found via a centroid method and recorded in a list. The two lists were compared to see whether an RSO had failed to be predicted, or whether the prediction had false positives present. Where the centers of these pixel clusters were very close to a known RSO, the prediction was considered a success. Where the centers were not close, the model was considered to have missed the target. In the simulated images, the RSOs are usually 3 pixels in width, so the prediction was considered successful if the centers were within 5 pixels of each other. The centers of the prediction and the truth mask were found to be on average half a pixel off, demonstrating that the location of the predictions were extremely accurate. The distance metric demonstrates a more meaningful metric to measure the model's accuracy, as the distance metric is not based on the overall percentage of object pixels detected, but rather the quantity of RSOs in the image. Such experiments were later repeated with real images.

The most performant of several generated and trained models was selected for subsequent evaluation of accuracy and error.

An analysis was conducted on the model's predictive certainty. The model ingests a greyscale image as input. The model normalizes the data in the input greyscale image from zero to one, i.e., assigns to each pixel of the image a Boolean value of 0 or 1 to represent black or white, respectively. The model interprets the grey colours to decide whether or not each pixel is part of an RSO. The model outputs a prediction normalized in the same manner. This threshold represents the model's certainty that a pixel(s) in question is an RSO or part thereof. The model's output is a Boolean matrix (a matrix containing numbers between 0 and 1 corresponding to each pixel in the image. This number (0-1) represents the model's certainty that that pixel is an RSO. For example, if one pixel is assigned 0.7, the model is 70% sure that pixel is an RSO pixel.

Various thresholds were tested to identify which provided the best threshold, starting at pixels above 0.50 and going as low as 0.10. Such a threshold refers to how sure the model had to be that the pixel in question was an RSO for the output to count it as an RSO. The optimal threshold encountered was 0.5, meaning the model had to be 50% sure that the pixel was an RSO for it to count in the output. If the model thought there was a 40% probability the pixel in question was an RSO, the model rounded down the probability to 0.

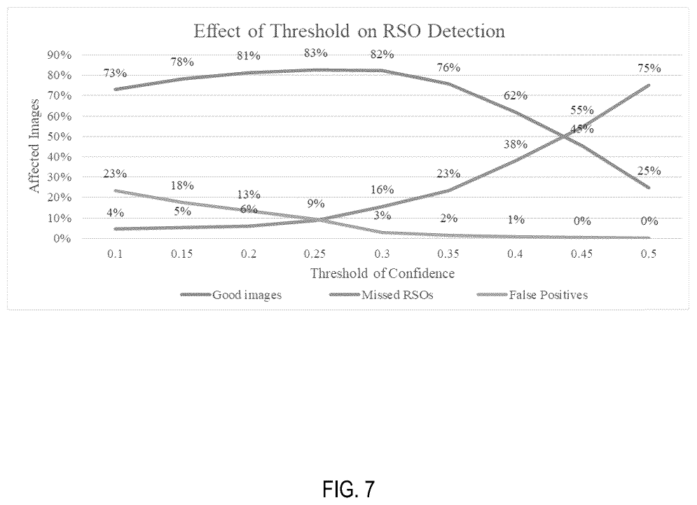

FIG. 7 shows a graph of an analysis of the threshold's effect on the trained model's accuracy over multiple datasets including star streaks of random lengths and widths, low to medium noise. Some datasets include filtered edges used to prevent star streaks from appearing on the edges of the testing images as, during training, the model may advantageously hone in on these cases and would focus on them. Each dataset is a collection of simulated images and their associated truth masks for validation.

A plurality of datasets with different features were combined to make a large dataset with many different types of images. Features included in the large dataset were:
Star streaks of random lengths and widths;
Low to medium noise;
Filtered edges; and
Regular edges.

As the threshold increased, false positives trended to 0% occurrence but missed RSOs began to increase. When the threshold decreased, missed RSOs were reduced toward zero, but false positives were reported more frequently.

A threshold of 0.25 demonstrated the optimal balance between false positives and missed detections, which aligned with the overall maxima of successful predictions. This threshold was calculated specifically for the model selected for analysis. Should this experiment be repeated using a different model or on different data, this threshold would be tuned again through similar analysis.

In using a U-Net-trained model for RSO detection in an operational systems context, both false positives and missed RSOs may be mitigated through the use of tracklet (or time series) data as well as complementary on-board data sources. If a given data source (e.g., a sensor acting as a complementary on-board data source) is a first-order (i.e., direct) input to the trained model, the model's threshold is tuned to not miss RSOs and uses validation sub-routines for filtering false positives. For this testing and experimentation, a threshold was selected to optimize the intersection of the lowest number of both missed RSOs and false positives.

Several metrics were used to quantify the model's results. The “mean distance” refers to the amount of pixels between the center of the truth mask RSO and the predicted RSO. The mean distance measures the accuracy of the location positioning of the model's prediction. The metrics described in Table 1-1 outline the results seen from a validation dataset including dimmer RSOs, limited background noise, and no pronounced star streaking (sometimes found in input images). The results from validation on a clean dataset such as the foregoing validation dataset are very good.

TABLE 1-1
Performance Results, First Dataset

| | |
|---|---|
| Percentage of images without issues | 93.4% |
| Final mean distance | 0.497 pixels |
| Percentage of images with detected issues | 6.60% |
| Average number of bad RSOs per bad image | 1.13 |
| Percentage of images with a missed RSO | 5.71% |
| Percentage of images with a false positive | 1.15% |

This model has been further tested in order to understand its strengths and limitations. This was achieved by validation on datasets with more features and noise added than used in training. As expected, there was a slight reduction in accuracy, but the model remained accurate in its predictions. Table 1-2 shows the results from a dataset with much thicker star streaks and much higher levels of background noise than the set used in training.

TABLE 1-2
Performance Results, Second Dataset

| | |
|---|---|
| Percentage of images without issues | 83.8% |
| Final mean distance | 0.527 pixels |
| Percentage of images with detected issues | 16.2% |
| Average number of bad RSOs per bad image | 1.14 |
| Percentage of images with a missed RSO | 11.8% |
| Percentage of images with a false positive | 4.78% |

From the results of Table 1-2, the trained and model has demonstrated an accuracy rate of 83.8%, where each prediction has a mean distance of 0.5 pixels from the truth mask center.

The small detection error is driven by a multitude of factors. Sometimes the RSO was very dim, and the model failed to find it. In other cases, the RSO was close to a star streak and may have been misinterpreted as part of the star structure. Most false positive detections appear to occur at end points of the star streaks. It is possible the model misinterpreted the star streak's rounded edges as an RSO. Overall, errors appear with low occurrence even on noisy datasets, and it is possible that further training with additional datasets or using time series data may improve the accuracy.

The mean distance between the predicted location and the truth mask location is extremely small, usually only half a pixel off from the truth mask location. This result demonstrates that the RA and DEC coordinates generated from the prediction are quite accurate and may be used in orbit calculations and propagations. With additional datasets for training and testing, the error margin in the coordinates returned from the model's predictions may be further decreased.

In an embodiment, input to the U-Net-trained model includes an image that is 256 by 256 pixels in dimensions, with a single channel. The image is normalized along the greyscale. Such normalization may be achieved by dividing values of the input image (i.e., the pixels) by a factor of 255 (equivalent to 0xFF in hexadecimal representation).

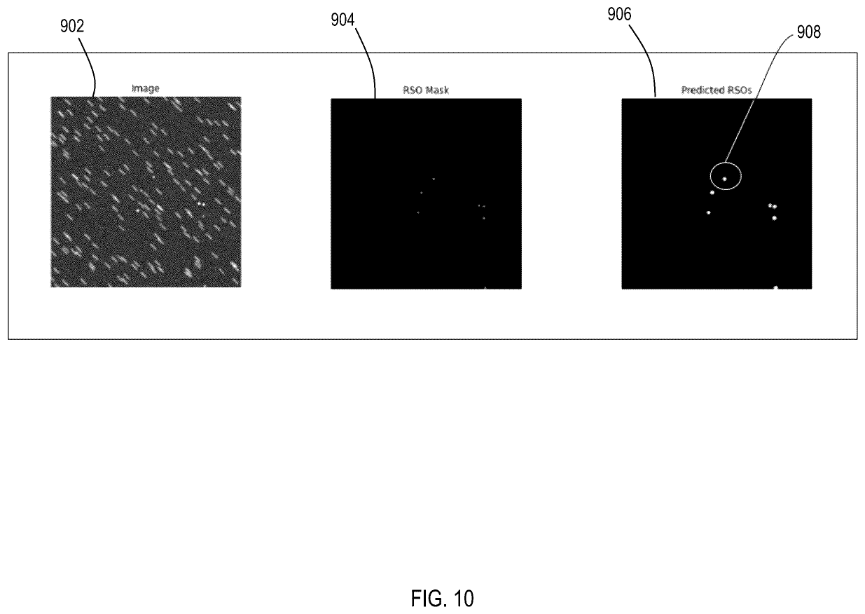

The output in the foregoing embodiment (see, for example, FIG. 10) also includes an image that is 256 by 256 pixels in dimensions with a single channel. The output image advantageously displays only the RSOs in the original image, if any RSOs were present therein. Accordingly, the truth mask image used during the model training for validation is generated including only “on” or “off” pixels. Pixels are “on” only if a RSO is present and are otherwise “off”. There is no noise or any other artifacts present in the generated truth mask image.

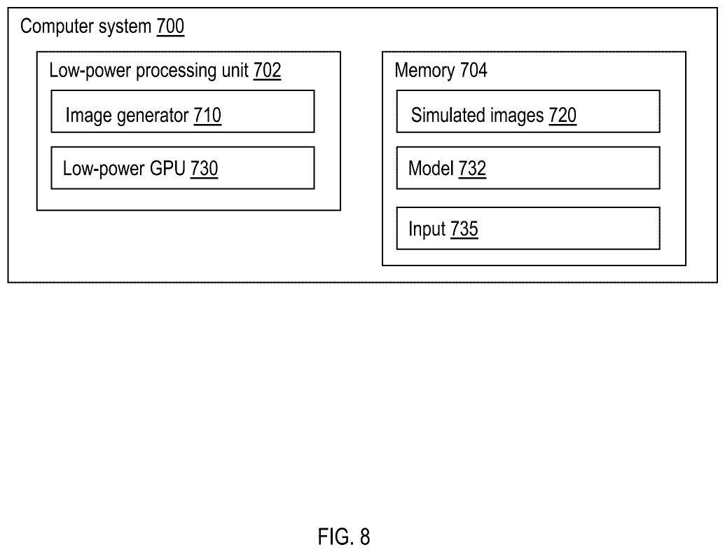

Referring now to FIG. 8, shown therein is a computer system 700 for implementing the modified U-Net CNN 600, according to an embodiment. In FIG. 8, like numerals denote like references with respect to FIG. 4.

The low-power processing unit 702 advantageously performs the functions of a processor in a low-power context, e.g., during operations of a robotic device after launch in space where excess hardware is not available for computing. The low-power processing unit 702 includes a low-power GPU for performing the foregoing functionality in the low-power processing unit 702.

The memory 704 includes a model 732 for detecting RSOs. The model 732 is as discussed in respect of FIGS. 4-8. The model 732 may be generated by a U-Net, such as the U-Net 600 of FIG. 6. The model 732 is generated by training the modified U-Net 600, which outputs the model 732. The model 732 may thus be considered to be already trained.

The model 732 is loaded and run on the low-power processing unit 702. The model 732 receives input 735 (e.g., further images) to detect RSOs therein or make predictions as to RSOs therein.

In an embodiment, the model 732 was run on a Xavier Jetson AGX GPU. The model 732 was created and its variables frozen. The model 732 was converted to the ONNX format for running inferences on the low-power GPU 730. The newly generated ONNX file 732 was loaded onto the low-power processing unit 702. An executable was set up on the computer system 700 to ingest an input 735 (e.g., an input image) and use the trained model 732 to run a prediction.

Experimentation was conducted as to the effects of the various power modes offered by the Xavier Jetson AGX. The Xavier Jetson AGX provides various power budgets, CPU/GPU frequencies, number of cores, and other options. There are 8 modes in total, as outlined in Table 1-3.

TABLE 1-3
Nvidia Xavier Jetson AGX Power Modes

| Mode ID | 0 | 1 | 2 | 3 | 4 | 5 | 6 | 7 |
|---|---|---|---|---|---|---|---|---|
| Power Budget | Uncapped | 10 W | 15 W | 30 W | 30 W | 30 W | 30 W | 15 W |
| Online CPU | 8 | 2 | 4 | 8 | 6 | 4 | 2 | 4 |
| CPU Max Frequency (MHz) | 2265.6 | 1200 | 1200 | 1200 | 1450 | 1780 | 2100 | 2188 |
| GPU Max Frequency (MHz) | 1377 | 520 | 670 | 900 | 900 | 900 | 900 | 670 |
| DLA Max Frequency (MHz) | 1395.2 | 550 | 750 | 1050 | 1050 | 1050 | 1050 | 115.2 |
| PVA Cores | 2 | 0 | 1 | 1 | 1 | 1 | 1 | 1 |
| PVA Max Frequency (MHz) | 1088 | 0 | 550 | 760 | 760 | 760 | 760 | 115.2 |
| Max Frequency | 2133 | 1066 | 1333 | 1600 | 1600 | 1600 | 1600 | 1333 |

In Table 1-3, DLA represents Deep Learning Accelerator, and PVA represents Programmable Vision Accelerator.

Each of these modes was tested, and the trained model 732 ran inference on a set of 100 test images as the input 735. Inference speed refers to the time required for the model 732 to process the input 735 and make a prediction.

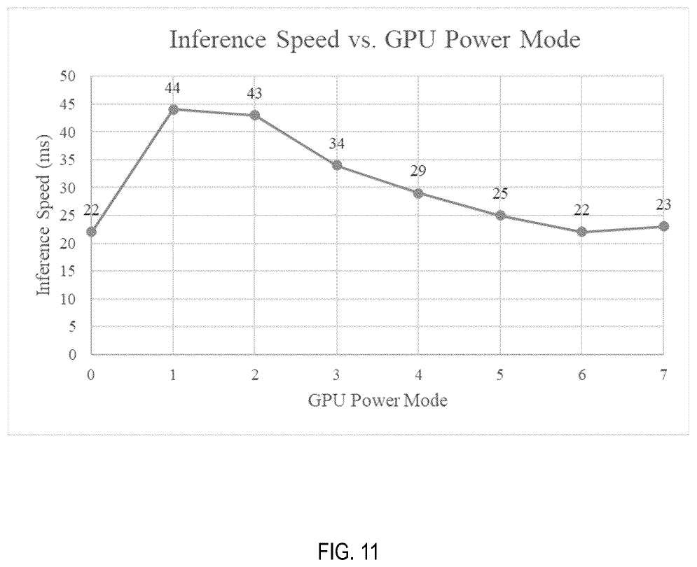

Referring now to FIG. 11, shown therein is a chart showing inference speed vs. GPU power mode and displaying findings based on the statistics of the varying power modes, according to an embodiment. Using floating point 32 data input in the reference, Mode 0 and mode 6 demonstrated the best results.

Referring again to FIG. 10, from the general trend depicted above, it appears the CPU frequency plays a higher role in the inference speed of the trained model 732 rather than power allocated to the low-power processing unit 702. Power mode 7 most closely resembles a space-qualified low-power processing unit 702, and by extension, it is concluded that predictions should be available to be made in approximately 23 ms.

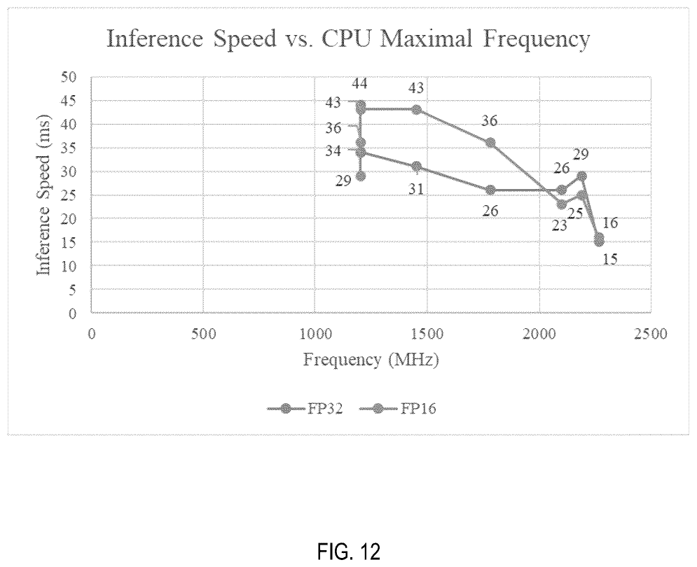

Referring now to FIG. 12, shown therein is a chart displaying CPU maximal frequency vs. inference speed, according to an embodiment. FIG. 12 shows an expected trend in that, as the frequency of the low-power GPU 730 increases, the time required for inference decreases. FIG. 14 further shows that, at lower frequencies, FP32 (single precision floating point format) is faster than FP16 (half-precision floating point format). However, as the frequency of the low-power GPU 730 increases, the difference becomes immaterial. The multiple datapoints at 1200 MHz correspond to the different power modes running at said frequency, as defined above in Table 1-3.

Referring again to FIG. 10, when a final space-qualified low-power GPU 730 is selected for a particular flight, these analyses may be rerun to optimize for the exact hardware identified for the mission system.

The system 700 may advantageously be suitable for providing a closed-loop decision support solution for on-orbit situational awareness and autonomous flight control.

The system 700 may advantageously enable an image simulator (such as the image simulator 305 of FIG. 4) to model time series data including a broader range of optical payloads.

The system 700 may advantageously enable the use of on-orbit SSA payload mission data including broad temporal archives of image orientation, features, and errors. In conjunction with images using wide FOV sensors, such enablement may advantageously provide a significant expansion of capability to the foregoing disclosure.

The datasets to be used in a prototype of the foregoing are modelled after images with a limited FOV.

Training detection algorithms on images from hemispherical lenses may further allow for the presence of many more objects in the frame and more computing workload.

The image simulator 305 is configured to adjust brightness configurations to emulate RSOs with varying lighting conditions and incident angles.

In an embodiment, more configurable types of noise are added, including simulating non-responsive or dead pixels whose output will fluctuate and not provide consistent readings.

In an embodiment, the image simulator 305 simulates images 320 having broad temporal datasets to allow training of a model 732 using a full catalogue of changing visual magnitudes in RSOs as well as a greater collection of varying image features.

Abilities of the trained model 732 trained according to the foregoing include detection and tracking of low Earth orbit (“LEO”) satellites.

The system 700 may be configured to use batch or tracklet images (images acquired over a number of seconds). Such batch or tracklet images may advantageously be more representative of operational payload data for SSA missions. Image segments thereof (not shown) improve detection accuracy where RSOs may overlap with a background star for a single image frame. The preliminary results of the foregoing experimentation were adjusted to take this into account as it is assumed that time-series input data would mitigate this challenge.

Other suitable devices for implementing the computer system 700 may include the Innoflight CFC-500.

Another suitable device is the CFC-500 (which supports the Compute Unified Device Architecture (CUDA) runtime environment). Such an environment advantageously permits transfer of the trained model 732 with minimal complications Because the system 700 has a similar architecture and runtime environment to the hardware implementing the modified U-Net 600 on which the trained model 732 was generated, the trained model 732 advantageously runs the same way on the system 700. The low power requirements of such devices represent an advantage in the constrained system common to satellites in orbit. The CFC-500 further includes two Nvidia Tegra K1 chips, which may decrease inference times and may be suitable to handle a broader system.

In an embodiment, the foregoing disclosure further includes discerning RA and DEC coordinates from optical images.

As range information remains important for orbit determination, and by extension, collision risk assessment, the present disclosure expressly contemplates the introduction of multi-modal input types such as radar, LiDAR, or even stereoscopic images to the SSA system.

With multi-modal inputs, a system enables a spacecraft to create its own situational awareness crucial to closed-loop decision support systems.

In an embodiment, the SSA OBP enables an end-to-end prototype system for the onboard detection of RSOs in optical image data.

The systems, methods, and devices of the present disclosure have been developed using an ML algorithm created with simulated images of RSOs among a background of star streaks in space.

Utilizing thousands of simulated images, a modified U-Net CNN model was successfully trained with a 99.8% reduction of weights from the standard model. Varying details of the simulated images demonstrated that the model may successfully predict in a multitude of lighting conditions.

Accuracy of the model was assessed by measuring the distance between the center of the predicted RSO and the center of the truth mask RSO. Verification of the predicted images showed that the location of predicted RSOs is extremely accurate, often not more than half a pixel off-centered, with an 83% accuracy.

When this model was run on a GPU, it could run inference at about a speed of 23 ms at around 15 W power budget and 2000 MHz maximal frequency.

The model is able to be retrained for different input image sources.

The foregoing demonstrates utility in the SSA domain and enables various applications, from an initial collision detection system to autonomous maneuvering decisions of spacecraft.

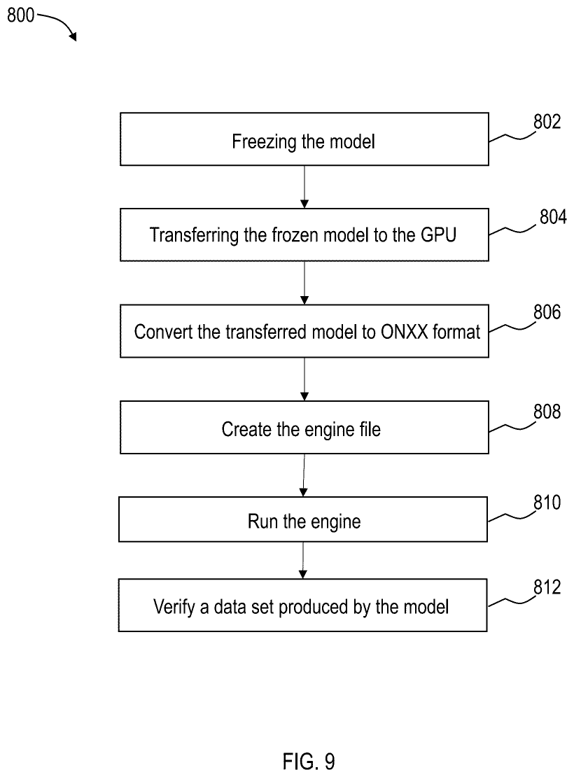

Referring now to FIG. 9, shown therein is a method 800 for implementing a trained RSO detection model on a GPU, according to an embodiment.

The trained model may be the trained model 732 of FIG. 8. The GPU may be the low-power GPU 730 of FIG. 8. The GPU may be, for example, an Xavier Jetson AGX GPU or the like. The trained model may be trained according to simulated images 320 of FIG. 4. The method 800 may implement the method 100 of FIG. 1 at 106. At 802, the method 800 includes freezing the trained model.

When a model is trained, the model maintains variables (e.g., weights) in its layers so that, if training continues, the variables may be updated in order to provide for greater accuracy, i.e., the model learns during training. Freezing a graph turns the variables into constants, meaning the model at that point is no longer susceptible to further training or alteration. The resulting trained model may be read in by programs, particularly as a smaller file.

At 804, the method 800 includes transferring the frozen model to the GPU.

In an embodiment, the model and files supporting the model are made with Python 3.6 Tensorflow 2.x in the h5 and pb formats. That the model is frozen at 802 permits conversion to a UFF format.

At 806, the method 800 includes converting the transferred frozen model to an open neural network exchange (“ONNX”) format.

The unified file format (“UFF”) previously common to the art is an older format losing support from developers. Moreover, UFF presents a single channel input/output where the “reshape” operation interferes with predictions of the model. Advantageously, converting the transferred frozen model to ONNX provides for better support.

The converted ONNX model is uploaded to the GPU.

At 808, the method 800 further includes creating an engine file, which is a precompiled version of a model (such as the model 732) that has been optimized for a specific GPU architecture. In an embodiment, the engine file is created using Nvidia's TensorRT library. The engine file and the ONNX file are different representations of the model. Advantageously, the engine file may put the ONNX file in a different format that the GPU is able to understand.

The engine file runs the transferred, frozen model in ONNX format.

Advantageously, the engine file may make changes to optimize the model to run on the GPU.

At 810, the method 800 includes running the engine.

Performance of the inference may be recorded to enable a determination as to which type of inference engine is optimal for a given model. Inference refers to the action of doing the prediction. The model runs on a piece of hardware called the inference engine. Multiple inference engines are provided on the Xavier Jetson AGX GPU).

At 812, the method 800 includes verifying a data set produced by the trained model run on the engine at 810.

In an embodiment, once the model is generated, the model is kept in a hierarchical data format (HDF), such as the “h5” (HDF5) file format. HDF5 is used to store large amounts of data in the form of multidimensional arrays. A data set may be made of images generated by the image simulator. The number of images and the specifications of their contents differs between them based on the configuration options at the time of generation, but there are some areas that are the same amongst all datasets. These are: for every simulated image, a corresponding mask image including only RSO pixels is also generated; each simulated image includes star streaks; and each simulated image and corresponding mask image is square.

Further non-exhaustive details that are variable among the data sets may be determined by the image simulator, including: the length and thickness of the star streaks; the level of noise present in the simulated image; and the amount, position, size, and brightness of RSOs present in the simulated image (and thus present in the corresponding mask image).

Once a dataset is gathered and the model is trained, verification and validation are performed. Information including detection accuracy, precision, and inference speed is collected. The verification may be performed through a script or other program essentially acting as a repetition of the image validation without altering the trained model. In validation, an input image to filter for RSOs is provided and run through the model to output a resulting prediction image. This prediction image is compared against the known truth mask for the input image to compare the accuracy of the prediction. Various factors are tested for, such as proximity of the centers of the blobs of pixels representing the RSOs between the actual and predicted images, whether the predicted image has the correct amount of RSOs, and/or whether a star has been falsely identified as an RSO.

Referring now to FIG. 10, shown therein are an exemplary simulated image 902, mask image 904, and output image (prediction) 906, according to an embodiment. The RSO detection model (not shown) may be the model 732 of FIG. 8.

After training, the RSO detection model may be implemented according to the method 800 of FIG. 9. The RSO detection model may include functionality of the method 100 of FIG. 1 at 108.

The simulated image 902 is input to the RSO detection model.

The simulated image 902 may be part of a simulated training dataset 14 generated as part of the pipeline 10 of FIG. 2. The simulated image 902 may be the simulated image 320 of FIG. 4.

The mask image 904 represents expected results of the RSO detection model in identifying RSOs in the simulated image 902.

The mask image 904 shows only the RSOs present in the simulated image 902, for example omitting all star streaks.

The output image 906 includes identified RSOs 908. To promote clarity, only a single RSO 908 is labelled in FIG. 10, and this RSO is encircled.

It is to be understood that the RSO 908 is the point inside the indicated circle, and that the other points in the output image 906 are similarly RSOs. The entire circle labelled 908 is not itself an RSO.

In an embodiment, the RSO detection model includes a plurality of features. The input tensor shape is different to that of a standard U-Net input in order to support a greyscale square image. The RSO Detection Model has fewer layers than a conventional U-Net model, which advantageously contributes to the foregoing reduction in layers and greater efficiency of the modified U-Net and output trained model. The RSO Detection Model makes use of different layers to achieve a similar result without bloating the model, for example Conv2dTranspose, which is a combination of other layers (such as Conv2D and Transpose) to operate in a more efficient manner. The RSO Detection Model has approximately 50.000 trainable parameters compared to the approximately 31,000,000 that a conventional U-Net model has. The output layer for the RSO Detection Model is set to have a “sigmoid” activation instead of “relu,” leading to an output that is always 0 or 1, i.e., the output prediction image has two values for a pixel, on or off. A pixel(s) in the predicted image is either part of an RSO or is not part of an RSO.

The output image may be considered a large matrix of 0's and 1's. When the padding for each layer in the RSO Detection Model is set to “valid,” meaning there is not padding with zeroes, the output image is made as small as possible, only keeping the relevant information (i.e., the 1's). In the application of the present disclosure to the RSO detection context, the only pixels that are 1's are the RSOs. For a given output image, there may be comparatively few such 1's. Thus, when the padding is set to “valid”, the vast majority of the image (all the 0's) is trimmed, leaving a comparatively small matrix of 1's with some 0's. When the padding is set to “same”, the entire matrix is kept, including the 0's, meaning the matrix is always the same size.

The loss function used in the foregoing was originally weighted with respect to cross entropy. Experimentation has revealed that a focal loss function is particularly suitable when the input classes for image segmentation models are imbalanced. In an embodiment, in the model, there is only a single class, namely whether a pixel(s) is an RSO or part thereof. A pixel is labelled as either an RSO or not an RSO, with a value between [0, 1] representing confidence in the prediction.

The focal loss, unlike cross entropy loss, examines positive cases only and does not consider the negative cases. For example, even where there are numerous RSOs in an image, each RSO is only a small grouping of pixels (e.g., if there are 8 RSOs in an image, the total such pixels may only represent 2% or less of the image).

For validation and testing, when choosing a dataset, the dataset is preferably homogenous or taken from the same source. Segregation of test data is a priority so as to minimize bias from peeking or allowing a model to train or tune on a test dataset or labels thereof. Varying datasets avoids the risk of the model training to focus on certain points only present in a training set. Training on different data sets leads to the model being more generalized and thus a better predictor. Where the data is not time series data, the entire span of the dataset is available for segmentation for training, validating, and testing. In embodiments where computational resources are strained but the dataset is relatively large, it would be beneficial to segment the dataset into a test-train split and further segment the train set into train and validate subsets. While optimal splits may be project-specific, common splits often resemble 80/10/10, or 60/20/20.

When the training data is being fit to a model (such as the model 732), results may be indicative of underfitting, overfitting, or correct fitting. Underfitting arises when there are too few independent variables or labels compared to the amount of observations.

When a trained model (such as the trained model 732) is underfit, the trained model may miss trends in the data. When a trained model is overfit, the trained model focuses in on details that were specific to the provided data set and loses generality. For instance, if the specific training set had only star streaks pointing a specific way, the model may expect all subsequent star streaks to be oriented in that specific way and may be unable to tell what a star streak is if it is oriented in a different manner.

In model training, validation, and testing, it is important that data be proportionate across all samples of the population to remove biases and potential for overfitting. In experimentation, a single label representing the amount of RSOs present in an image, ranging from 0 to 8, was chosen. Sets were sorted and divided according to a predefined split factor (70/15/15) for training, validation, and testing, respectively. The test dataset was completely segregated to ensure the model had no access thereto prior to actual testing.

The training set was made up of simulated images 320 generated from the image simulator 305. None of the simulated images 320 had overlap with RSOs and star streaks. In a real-world environment, such a conjunction is short-lived, and so this corner case is not a concern. The training set included images with zero, single, and multiple RSOs present in the simulated images 320. All images have star streaks and a level of background noise.

The validation set is a portion of the training set, i.e., the validation set includes pictures of the same style generated at the same time. The validation set is separated from the training set before training the model in order to validate the model on images it has not seen before.

The testing set was made up of simulated images 320 generated as in the training set. In this experiment, the testing set was taken from the same pool of simulated images 320 as the training set. However, none of the simulated images 320 in the validation set were previously in the training set.

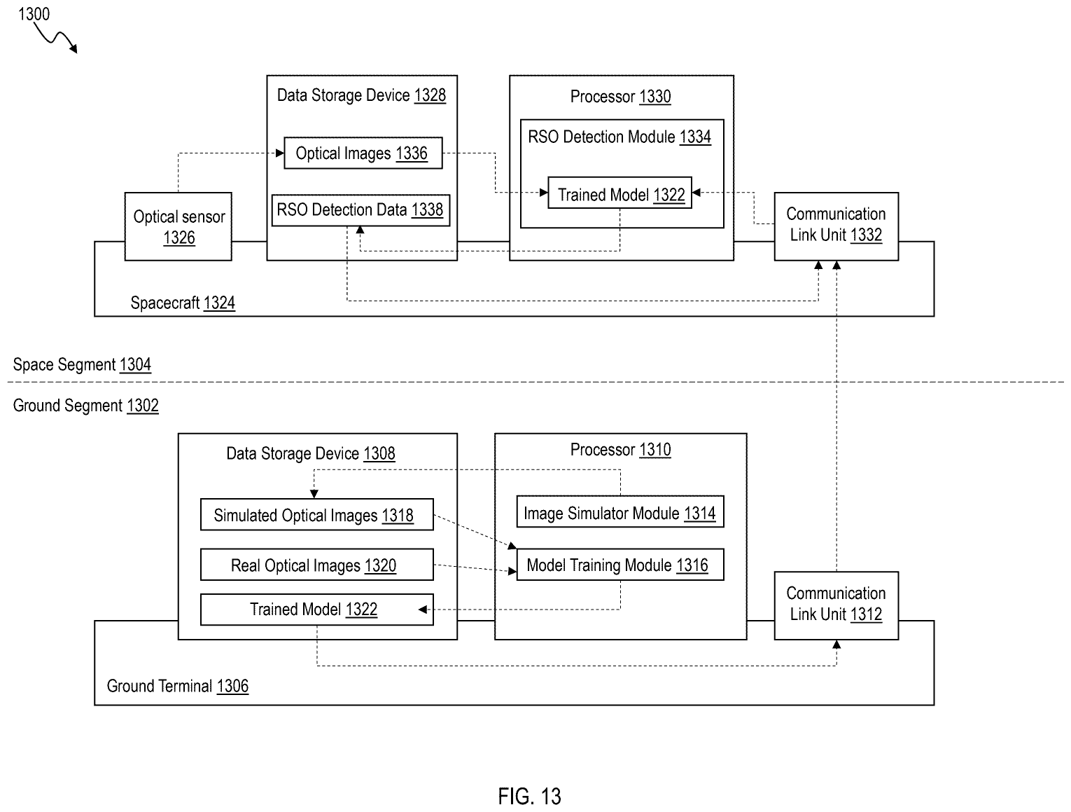

Referring now to FIG. 13, shown therein is a system 1300 for onboard detection of RSOs in optical imagery using machine learning, according to an embodiment. The system 1300 may implement any one or more of the methods, systems, or devices described hereinbefore.

The system 1300 includes a ground segment 1302 and a space segment 1304.

The ground segment 1302 includes a ground terminal 1306. The ground terminal 1306 includes a data storage device 1308, such as a computer memory, a processor 1310 in communication with the data storage device 1308, and a communication link unit 1312. The ground terminal 1306 may include a single device or platform or a plurality of devices or platforms (which may be local or remote to one another). Accordingly, components 1308, 1310, 1312 may be implemented at the same device or platform or across multiple devices or platforms.

The processor 1310 is configured to execute an image simulator module 1314 and a model training module 1316. The processor 1310 may further include a human-machine interface (not shown) for allowing a user to interact with the image simulator and the modules 1314, 1316.

The image simulator module 1314 is configured to generate simulated training images 1318 according to one or more methods described herein. The simulated training images 1318 are stored in the data storage device 1308.

The data storage device 1308 further stores real training images 1320. In variations, the system 1300 may use a combination of simulated and real training images 1318, 1320 for model training, only simulated images 1318 for model training, or only real images 1320 for model training. In embodiments using only real training images 1320, the processor 1310 may not include image simulator module 1314.

The simulated training images 1318 and/or the real training images 1320 are provided as input to the model training module 1316.

The model training module 1316 executes a machine learning algorithm to train an RSO detection model 1322 using the training data 1318, 1320, such as described herein. The trained model 1322 output by the model training module 1316 is stored in data storage device 1308.

The ground terminal 1306 uplinks the trained RSO detection model 1322 to the space segment 1304 via communication link unit 1312. In an embodiment, the trained RSO detection model 1322 is implemented by uplinking the model to the satellite. In another embodiment, the trained RSO detection model 1322 is implemented by putting the model on the processor on ground and further sending alongside the satellite when launched.

Referring now to space segment 1304, the space segment 1304 includes a spacecraft 1324. The spacecraft 1324 may be a satellite. The satellite may be part of a satellite constellation. The satellite may communicate with other satellites in the constellation by intersatellite link (e.g., optical, RF).

The spacecraft 1324 includes an optical sensor 1326 for collecting electro-optical imagery, a data storage device 1328 (e.g., a data storage device or the like), a processor 1330 in communication with the data storage device 1328, and a communication link unit 1332. The data storage device 1328 and processor 1330 are components of an onboard computer system (which may also be referred to as an onboard processor or OBP). The onboard computer system, and thus the data storage device 1308 and the processor 1310, may be implemented at a single computing device or across multiple computing devices.

The communication link unit 1332 receives the trained RSO detection model 1322 via uplink from the ground terminal 1306. It should be noted that while in FIG. 13 the trained RSO detection model 1322 is shown as uplinked to spacecraft 1324 from the ground segment 1302, in other embodiments, the trained RSO detection model 1322 may be uploaded from the ground terminal 1306 to spacecraft 1324 (i.e., to data storage device 1328, described below) in the ground segment 1302 prior to launch of the spacecraft 1324.

The trained model 1322 is implemented as part of an RSO detection module 1334 executed by the processor 1330. In some embodiments, the RSO detection module 1334 may be configured to optimize the model 1332 for onboard processing.

The optical sensor 1326 is configured to collect optical images 1336. The parameters of the imaging operations performed by the optical sensor 1326 may be determined by the processor 1330 (e.g., based on one or more commands or tasks received from the ground segment 1302).

The optical images 1336 are stored in the data storage device 1328.

The optical images 1336 are provided as input to the trained RSO detection model 1322. The RSO detection model 1322 performs machine learning-based RSO detection, such as described herein. In doing so, the trained model 1322 generates RSO detection data 1338. The RSO detection data 1338 describes RSOs detected in the optical images 1336. The RSO detection data 1338 is stored in the data storage device 1328.

The RSO detection data 1338 may be further processed by the processor 1330 (e.g., by the RSO detection module 1334).

The RSO detection data 1338 (whether raw or post-processed) is provided to the communication link unit 1332 for transmitting to a system external to spacecraft 1324, such as in the ground segment 1302 (e.g., the ground terminal 1306 or another ground terminal).

While the above description provides examples of one or more systems, methods, or devices, it will be appreciated that other systems, methods, and devices may be within the scope of the claims as interpreted by one of skill in the art.

1. A method of generating a simulated image for training an image segmentation model to detect resident space objects (RSOs), the method comprising:
generating a foreground of the simulated image, the foreground including RSOs, by:
calculating coordinates of an imaging satellite at a given time;
determining an area of interest given a field of view (FOV) of the imaging satellite; and
calculating coordinates of all RSOs and saving the coordinates if the RSO is within the area of interest;
generating a background of the simulated image, the background including stars, by:
querying a star catalogue database for coordinates of all stars that fall inside the FOV;
adding noise to the simulated image; and
translating RSO and star coordinates to pixel coordinates in the simulated image; and
generating the simulated image by:
choosing an imaging mode;
setting an exposure time; and
rendering the simulated image according to the imaging mode and the exposure time.

2. The method of claim 1, wherein calculating coordinates of all RSOs is performed using a propagation algorithm.

3. The method of claim 1, wherein the noise includes star streaks.

4. The method of claim 1, wherein the imaging mode is chosen from among sidereal tracking, target rate tracking, and a custom rate.

5. The method of claim 1, wherein calculating coordinates of all RSOs and saving the coordinates if the RSO is within the area of interest includes simulating orbit paths to generate a list of access windows when a foreground satellite is in the FOV.

6. The method of claim 5, wherein time stamps associated with each access window are slightly randomized so that the foreground satellite is not always centered in the simulated image.

7. The method of claim 5, wherein time stamps associated with each access window are used to calculate right ascension (RA) and declination (DEC) of all foreground satellites in the FOV.

8. The method of claim 7, wherein translating the RSO to the pixel coordinates in the simulated image is performed according to the RA and the DEC.

9. A method of training an image segmentation model to detect resident space objects (RSOs), the method comprising:
generating a training set by performing the method of claim 1 for a plurality of simulated images; and
training the image segmentation model using the training set and/or one or more real images.

10. The method of claim 9, wherein the method is performed on a low-power GPU or an FPGA.

11. A method of detecting resident space objects (RSOs) in an optical image, the method comprising:
inputting the optical image to a trained image segmentation model trained using the method of claim 9; and
detecting RSOs in the optical image using the trained image segmentation model.

12. A method of training an image segmentation model for detecting RSOs, the method comprising:
generating a simulated training dataset, the simulated training dataset comprising at least one simulated training image, wherein each simulated training image simulates a view from an imaging satellite or ground-based optical system;
curating the simulated training dataset by performing one or more of:
customizing the simulated training dataset for edge cases, different sensor types, and/or different image satellites; and
combining different simulated training datasets;
processing the simulated training dataset into a training subset, a testing subset, and a validation subset;
generating an RSO detection model by training a modified U-Net on the training subset;
verifying the generated RSO detection model with the testing subset; and
validating the generated RSO detection model by inputting the validation subset into plate-solving algorithms.

13. A method of detecting RSOs in an optical image, the method comprising:
generating simulated training images using an image simulator, wherein each of the simulated training images simulates a view from an imaging satellite or ground-based optical sensor and includes a simulated foreground including RSOs and a simulated background including stars;
training an RSO detection model using the simulated training images;
configuring the trained RSO detection model for onboard processing, the onboard processing being onboard a satellite; and
detecting RSOs in the optical image using the trained RSO detection model that has been configured for onboard processing.

14. The method of claim 13, wherein the image simulator applies a configurable scale of brightness that incorporates a pseudorandom element and generates a realistic brightness variation across the simulated training images, and wherein the sizes of the RSOs in the simulated foreground are randomized between 3 to 5 pixels in size.

15. A method of detecting RSOs onboard a satellite, the method comprising:
acquiring an optical image using an optical sensor onboard the satellite;
providing the optical image to a processor onboard the satellite, the processor executing an RSO detection model trained using a plurality of simulated training images simulating a view from an imaging satellite, each simulated training image including a simulated foreground including RSOs and a simulated background including stars;
detecting RSOs in the optical image using the RSO detection model; and
controlling an attitude of the satellite based on an output of the RSO detection model.

16. The method of claim 15, wherein the method is performed on a low-power GPU or an FPGA.
